(19) United States
(12) Patent Application Publication
(10) Pub. No.: US 2026/0019701 A1
(43) Pub. Date: Jan. 15, 2026

(54) ELECTRONIC DEVICE, CONTROL METHOD FOR ELECTRONIC DEVICE, AND PROGRAM

(71) Applicant: CANON KABUSHIKI KAISHA, Tokyo (JP)

(72) Inventor: SEIJI OGAWA, Tokyo (JP)

(21) Appl. No.: 19/337,188

(22) Filed: Sep. 23, 2025

Related U.S. Application Data
(63) Continuation of application No. PCT/JP2024/009266, filed on Mar. 11, 2024.

(30) Foreign Application Priority Data
Mar. 28, 2023 (JP) 2023-051690

(51) Int. Cl. H04N 23/63; G06F 3/01; H04N 23/667; H04N 23/67; H04N 23/69

(52) U.S. Cl. CPC H04N 23/632; G06F 3/013; H04N 23/667; H04N 23/675; H04N 23/69

(57) ABSTRACT

An electronic device includes: a detection unit configured to detect a gaze position of a user who views a display unit that displays a live-view image captured by an image capturing unit; an operation unit configured to receive an operation performed by the user; a mode switching unit configured to switch between an AF mode and an MF mode; and a control unit configured to execute, in the live-view image displayed on the display unit, (1) in the AF mode, a first process of determining a position where AF is to be executed based on the gaze position on the live-view image, and (2) in the MF mode, a second process for assisting manual focusing based on the gaze position on the live-view image, wherein, in the second process, performing control such that the second process is completed in response to completion of the specific operation.

### CROSS-REFERENCE TO RELATED APPLICATIONS

This application is a Continuation of International Patent Application No. PCT/JP2024/009266, filed, Mar. 11, 2024, which claims the benefit of Japanese Patent Application No. 2023-051690, filed Mar. 28, 2023, both of which are hereby incorporated by reference herein in their entirety.

### BACKGROUND

### Field of the Technology

The present disclosure relates to an electronic device, a control method for the electronic device, and a program.

### Description of the Related Art

Electronic devices equipped with “gaze input” technology, which allows operation based on a user's gaze, are known. The gaze input technology is particularly effective when a user operates an electronic device, such as a digital camera or a game console, and wishes to quickly perform an intended operation.

An electronic device equipped with gaze input technology executes a predetermined process at a gaze position corresponding to the detected gaze when it detects the user's gaze. For this reason, if the electronic device detects an unintended gaze movement, such as a slight eye movement that occurs even when the user tries to fixes their gaze on an object, the electronic device may execute an operation not intended by the user.

Japanese Patent Laid-Open No. 2022-68749 describes a technique for displaying an item at a gaze position detected when a specific operation is performed by the user, in order to prevent execution of a process corresponding to the user's unintended gaze movement, and for invalidating the user's gaze detected thereafter.

However, the electronic device described in Japanese Patent Laid-Open No. 2022-68749 is configured such that a process related to gaze input, executed in response to a specific operation performed by a user, is merely displaying an item at a position corresponding to the gaze position. For this reason, when multiple processes are to be executed based on gaze input, operation members corresponding to the individual processes are required, which may reduce the flexibility of other operations.

### SUMMARY

The present disclosure provides an electronic device capable of executing multiple processes related to gaze input in response to a specific operation performed by the user, a control method for the electronic device, and a program.

An electronic device according to an aspect of the present disclosure includes: a detection unit configured to detect a gaze position of a user who views a display unit configured to display a live-view image captured by an image capturing unit; an operation unit configured to receive an operation performed by the user; a mode switching unit configured to switch between an AF mode and an MF mode; and a control unit configured to execute, in response to a specific operation performed by the user on the operation unit, in the live-view image displayed on the display unit, (1) in the AF mode, a first process of determining a position where AF is to be executed based on the gaze position on the live-view image detected by the detection unit, and (2) in the MF mode, a second process for assisting manual focusing based on the gaze position on the live-view image detected by the detection unit, wherein, in the second process, performing control such that the second process is completed in response to completion of the specific operation.

Features of the present disclosure will become apparent from the following description of embodiments with reference to the attached drawings.

### BRIEF DESCRIPTION OF THE DRAWINGS

The accompanying drawings, which are incorporated in and constitute a part of the specification, illustrate embodiments of the present disclosure and, together with the description, serve to explain the principles of the present disclosure.

FIG. 1A is an external view of a digital camera, which is an example of an image capturing apparatus according to a first embodiment and is a perspective view of the front of the digital camera.

FIG. 1B is an external view of the digital camera, which is an example of the image capturing apparatus according to the first embodiment and is a perspective view of the back of the digital camera.

FIG. 2 is a block diagram illustrating the configuration of the digital camera, which is an example of the image capturing apparatus according to the first embodiment.

FIG. 3A is a flowchart illustrating processing in an image capturing mode of the digital camera, which is an example of the image capturing apparatus according to the first embodiment.

FIG. 3B is a flowchart illustrating processing in an image capturing mode of the digital camera, which is an example of the image capturing apparatus according to the first embodiment.

FIG. 3C is a flowchart illustrating processing in an image capturing mode of the digital camera, which is an example of the image capturing apparatus according to the first embodiment.

FIG. 4A illustrates a display example of a menu screen in which various settings of the digital camera, which is an example of the image capturing apparatus according to the first embodiment, are switched.

FIG. 4B illustrates a display example of a menu screen in which various settings of the digital camera, which is an example of the image capturing apparatus according to the first embodiment, are switched.

FIG. 5A illustrates an example in which an LV image is displayed on the screen of the digital camera, which is an example of the image capturing apparatus according to the first embodiment, in the image capturing mode.

FIG. 5B illustrates an example in which an LV image is displayed on the screen of the digital camera, which is an example of the image capturing apparatus according to the first embodiment, in the image capturing mode.

FIG. 5C illustrates an example in which an LV image is displayed on the screen of the digital camera, which is an example of the image capturing apparatus according to the first embodiment, in the image capturing mode.

FIG. 5D illustrates an example in which an LV image is displayed on the screen of the digital camera, which is an example of the image capturing apparatus according to the first embodiment, in the image capturing mode.

FIG. 5E illustrates an example in which an LV image is displayed on the screen of the digital camera, which is an example of the image capturing apparatus according to the first embodiment, in the image capturing mode.

FIG. 5F illustrates an example in which an LV image is displayed on the screen of the digital camera, which is an example of the image capturing apparatus according to the first embodiment, in the image capturing mode.

FIG. 5G illustrates an example in which an LV image is displayed on the screen of the digital camera, which is an example of the image capturing apparatus according to the first embodiment, in the image capturing mode.

FIG. 5H illustrates an example in which an LV image is displayed on the screen of the digital camera, which is an example of the image capturing apparatus according to the first embodiment, in the image capturing mode.

FIG. 5I illustrates an example in which an LV image is displayed on the screen of the digital camera, which is an example of the image capturing apparatus according to the first embodiment, in the image capturing mode.

FIG. 5J illustrates an example in which an LV image is displayed on the screen of the digital camera, which is an example of the image capturing apparatus according to the first embodiment, in the image capturing mode.

FIG. 5K illustrates an example in which an LV image is displayed on the screen of the digital camera, which is an example of the image capturing apparatus according to the first embodiment, in the image capturing mode.

FIG. 5L illustrates an example in which an LV image is displayed on the screen of the digital camera, which is an example of the image capturing apparatus according to the first embodiment, in the image capturing mode.

FIG. 6 is a schematic diagram illustrating the display layers of the GUI components of the digital camera, which is an example of the image capturing apparatus according to the first embodiment.

FIG. 7 illustrates an example in which an in-focus state is displayed on the display unit of the digital camera, which is an example of an image capturing apparatus according to a second embodiment.

FIG. 8A is an external view of a head set including a head mount display (HMD) according to a third embodiment.

FIG. 8B is an external view of the head set including the head mount display (HMD) according to the third embodiment.

FIG. 8C is an external view of a game controller serving as an operation member according to the third embodiment.

FIG. 9A illustrates a display example of a game screen displayed on the HMD according to the third embodiment.

FIG. 9B illustrates a display example of a game screen displayed on the HMD according to the third embodiment.

FIG. 9C illustrates a display example of a game screen displayed on the HMD according to the third embodiment.

FIG. 9D illustrates a display example of a game screen displayed on the HMD according to the third embodiment.

FIG. 9E illustrates a display example of a game screen displayed on the HMD according to the third embodiment.

FIG. 9F illustrates a display example of a game screen displayed on the HMD according to the third embodiment.

FIG. 10A illustrates an example of a video editing screen of a personal computer (PC) according to a fourth embodiment.

FIG. 10B illustrates an example of a video editing screen of a personal computer (PC) according to the fourth embodiment.

### DESCRIPTION OF THE EMBODIMENTS

Preferred Embodiments of the present disclosure will be described in detail hereinbelow with reference to the accompanying drawings. In this specification and drawings, duplicated descriptions of components having substantially the same functional configurations will be omitted.

### First Embodiment

### Configuration of Image Capturing Apparatus

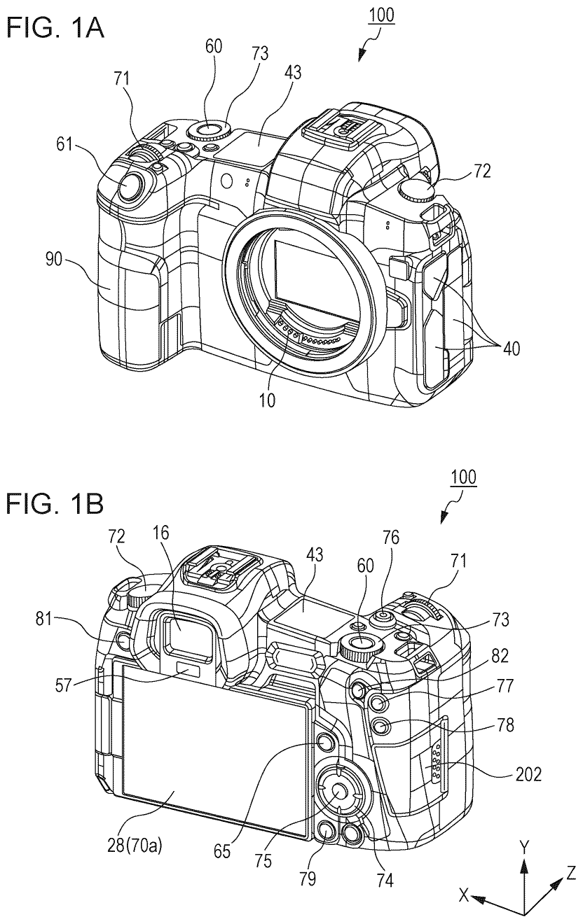

FIGS. 1A and 1B are external views of a digital camera 100, which is an example of an image capturing apparatus according to a first embodiment. FIG. 1A is a perspective view of the front of the digital camera 100. FIG. 1B is a perspective view of the back of the digital camera 100.

A display unit 28 is provided on the back of the digital camera 100 and displays images and various items of information. A touch panel 70a allows detection of a touch operation on the display surface (a touch operation surface, a touch operation member) of the display unit 28. A viewfinder-external display unit 43 is provided on the upper surface of the digital camera 100 and displays various setting values of the digital camera 100, including a shutter speed and an aperture. A shutter button 61 is an operation member for giving an imaging instruction (image capturing instruction). A mode changeover switch 60 is an operation member for switching among various modes. Terminal covers 40 are covers for protecting connectors (not shown) for connecting the digital camera 100 to external devices.

A main electronic dial 71 is a rotary operation member, which is configured to, for example, change the setting values, such as a shutter speed and an aperture, by being rotated. A power switch 72 is an operation member for switching between on and off of the power source of the digital camera 100. A sub-electronic dial 73 is a rotary operation member, which is configured to, for example, move a selection frame (cursor) or feed images, by being rotated. A four-way key 74 is configured to depress upper, lower, left, and right portions, allowing a process corresponding to a pushed portion of the four-way key 74. A set button 75 is a push button, which is mainly used to determine a selection item.

A multi controller (hereinafter referred to as “MC”) 65 is capable of accepting an indication in eight directions and a push operation at the center. A video button 76 is used to give an instruction to start or stop moving-image capturing (recording). An automatic exposure (AE) lock button 77 is s push button, which can fix an exposure state by being depressed in an image capturing standby state.

A zoom button 78 is an operation button for switching between ON and OFF of a magnification mode in a live view display (LV display) on a standby screen in an image capturing mode. The live-view image (LV image) can be magnified or reduced by turning on the magnification mode and then operating the main electronic dial 71. In a playback mode, the zoom button 78 functions as an operation button for magnifying a playback image or increasing the magnification ratio. A playback button 79 is an operation button for switching between the image capturing mode and the playback mode. By pushing the playback button 79 during the image capturing mode, the mode can be transitioned to the playback mode, and the last image among images recorded in a recording medium 200 (described later) can be displayed on the display unit 28.

A menu button 81 is a push button used to give an instruction to display a menu screen. When the menu button 81 is pushed, a menu screen that allows various settings is displayed on the display unit 28. The user can intuitively perform various settings using the menu screen displayed on the display unit 28, the four-way key 74, the set button 75, or the MC 65.

An autofocus (AF)-ON button 82 is an operation member included in an operating unit 70. The AF-ON button 82 is a push button. By depressing the AF-ON button 82, an AF (autofocus) process can be started. The AF process can be started mainly by depressing the shutter button 61; however, the AF process can also be started by depressing the AF-ON button 82. The AF-ON button 82 is disposed at a position at which the user can easily operate it even in a state in which the user looks into the viewfinder (with their eye placed against an eyepiece 16), where it is operable using the thumb of the right hand holding a grip portion 90.

Communication terminals 10 are used to communicate with a lens unit 150 (described later), to which the digital camera 100 is detachably attached. The eyepiece 16 is the eyepiece section of an eyepiece viewfinder (look-in type viewfinder), which allows the user to visually recognize an image displayed on an internal electronic viewfinder (EVF) 29 (described later) via the eyepiece 16. An eye detection unit 57 is an eye detection sensor that detects whether the user's (photographer's) eye is in contact with the eyepiece 16. A cover 202 is a cover for a slot for housing the recording medium 200 (described later). The grip portion 90 is a holder shaped to be easily gripped with the right hand when the user holds the digital camera 100. The shutter button 61 and the main electronic dial 71 are disposed at positions operable with the index finger of the right hand in a state in which the digital camera 100 is held with the grip portion 90 gripped by the little finger, the ring finger, and the middle finger of the right hand. In the same state, the sub-electronic dial 73 and the AF-ON button 82 are disposed at positions operable with the thumb of the right hand.

### Description of Block Diagram

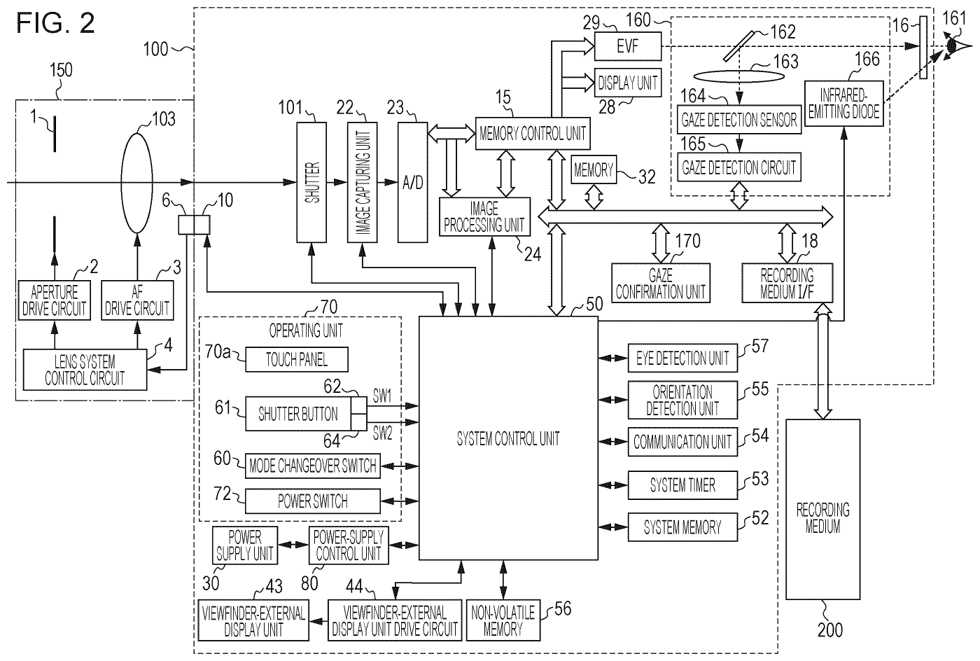

FIG. 2 is a block diagram illustrating the configuration of the digital camera 100, which is an example of the image capturing apparatus according to the first embodiment. A lens unit 150 includes an interchangeable lens.

A lens 103 generally includes multiple lenses; however, only one lens is illustrated in FIG. 2 for simplicity. A communication terminal 6 is used to allow the digital camera 100 to communicate with the lens unit 150 side. The communication terminals 10 are used to allow the digital camera 100 to communicate with the lens unit 150 side. The lens unit 150 communicates with a system control unit 50 via the communication terminals 6 and 10. The lens unit 150 controls an aperture 1 using an internal lens system control circuit 4 via an aperture drive circuit 2. The lens unit 150 focuses by displacing the lens 103 using the lens system control circuit 4 via an AF drive circuit 3.

A shutter 101 is a focal-plane shutter configured to freely control the exposure time of an image capturing unit 22 under the control of the system control unit 50.

The image capturing unit 22 is an image sensor composed of a charge-coupled device (CCD), a complementary metal-oxide semiconductor (CMOS) device, or the like that converts an optical image to an electrical signal. The image capturing unit 22 may include an imaging-plane phase-difference sensor that outputs defocus amount information to the system control unit 50.

An image processing unit 24 performs predetermined processes (for example, pixel interpolation, a resizing process such as reduction, and a color conversion process) on data from an analog-to-digital (A/D) converter 23 or a memory control unit 15. The image processing unit 24 performs a predetermined calculation process using captured image data. The system control unit 50 performs exposure control and distance measurement control based on a calculation result obtained by the image processing unit 24. Thus, through-the-lens (TTL) type AF processing, automatic exposure (AE) processing, and flash pre-emission (EF) processing, and the like are performed. The image processing unit 24 further performs a predetermined calculation process using the captured image data and performs a TTL type automatic white balancing (AWB) process based on the obtained calculation result.

The memory control unit 15 controls data transmission/reception among the A/D converter 23, the image processing unit 24, and a memory 32. Output data from the A/D converter 23 is written to the memory 32 via the image processing unit 24 and the memory control unit 15 or directly via the memory control unit 15 without passing through the image processing unit 24. The memory 32 stores image data captured by the image capturing unit 22 and converted to digital data by the A/D converter 23 and image data to be displayed on the display unit 28 or the EVF 29. The memory 32 has a storage capacity sufficient to store a predetermined number of still images and a video or audio for a predetermined period.

The memory 32 also serves as a memory for image display (video memory). The display image data written to the memory 32 is displayed by the display unit 28 or the EVF 29 via the memory control unit 15. Each of the display unit 28 and the EVF 29 performs display on a display device such as a liquid-crystal display (LCD) or an organic electroluminescence (EL) display in accordance with signals from the memory control unit 15. By transferring data that has been converted from analog to digital by the A/D converter 23 and stored in the memory 32 to the display unit 28 or the EVF 29 in sequence, LV display can be performed.

A gaze detection unit 160 (reception unit) detects the gaze of the user's eye placed against the eyepiece 16, directed toward the EVF 29. The gaze detection unit 160 includes a dichroic mirror 162, an imaging lens 163, a gaze detection sensor 164, a gaze detection circuit 165, and an infrared-emitting diode 166.

The infrared-emitting diode 166 is a light-emitting device for detecting a user's gaze position in the viewfinder screen and emits infrared light to a user's eyeball (eye) 161. The infrared light emitted from the infrared-emitting diode 166 is reflected by the eyeball (eye) 161, and the infrared reflected light reaches the dichroic mirror 162. The dichroic mirror 162 reflects only infrared light and allows visible light to pass through. The infrared reflected light whose optical path has been changed forms an image on the imaging plane of the gaze detection sensor 164 via the imaging lens 163. The imaging lens 163 is an optical member constituting a gaze detection optical system. The gaze detection sensor 164 is an imaging device such as a CCD type image sensor.

The gaze detection sensor 164 photoelectrically converts the incident infrared reflected light to an electrical signal and outputs the signal to the gaze detection circuit 165. The gaze detection circuit 165 detects a user's gaze position from the movement of the user's eyeball (eye) 161 based on the output signal from the gaze detection sensor 164 and outputs the detected information to the system control unit 50 and a gaze confirmation unit 170.

When a period during which the user's gaze is fixed on a certain region exceeds a predetermined threshold based on the detection information received from the gaze detection circuit 165, the gaze confirmation unit 170 determines that the user gazes at the region. Accordingly, the region can be regarded as a gaze position (gaze region) at which the user gazes. One example of “the gaze is fixed on a certain region” is that the average position of the movements of the gaze is within the region during an elapse of a predetermined period and its variations are less than a predetermined value. The predetermined threshold can be freely changed by the system control unit 50. The gaze confirmation unit 170 does not have to be provided as an independent block; the system control unit 50 may execute the same function as that of the gaze confirmation unit 170 based on the detection information received from the gaze detection circuit 165.

In the present embodiment, the gaze detection unit 160 detects the gaze using a method called the corneal reflection method. The corneal reflection method is a method for detecting the orientation and position of the gaze based on the positional relationship between reflected light that is reflected by the eyeball (eye) 161 (in particular, the cornea) after being emitted from the infrared-emitting diode 166 and the pupil of the eyeball (eye) 161. A method for detecting the gaze (the orientation and position of the gaze) is not limited and may be any method other than the above method. For example, a method called the scleral reflection method, which utilizes the difference in reflectance between the iris and the sclera, may be used.

The viewfinder-external display unit 43 displays various setting values including a shutter speed and an aperture via a viewfinder-external display unit drive circuit 44.

A non-volatile memory 56 is an electrically erasable/recordable memory, for example, a flash-read-only memory (ROM). The non-volatile memory 56 stores constants, programs, and the like for operating the system control unit 50. The “programs” referred to herein denotes programs for executing various flowcharts described later in the present embodiment.

A system control unit 50 is a control unit composed of at least one processor or circuit and controls the entire digital camera 100. The system control unit 50 implements the processes of the present embodiment, described later, by executing the programs stored in the non-volatile memory 56. A system memory 52 is, for example, a random-access memory (RAM). The system control unit 50 deploys constants, variables, and programs read from the non-volatile memory 56 for operating the system control unit 50 into the system memory 52. The system control unit 50 also performs display control by controlling the memory 32, the display unit 28, and the like.

A system timer 53 is a timer configured to measure time used for various controls and time of an internal clock.

A power-supply control unit 80 includes a battery detection circuit, a direct-current to direct-current (DC-DC) converter, and a switch circuit that switches between blocks to be energized, and performs detection of whether a buttery is mounted, the type of the battery, the remaining battery level, and the like. The power-supply control unit 80 controls the DC-DC converter based on its detection result and an instruction from the system control unit 50 to supply necessary voltages to components including the recording medium 200 for a necessary period. Examples of the power supply unit 30 include primary batteries such as an alkaline battery and a lithium battery, secondary batteries such as a nickel-cadmium (NiCd) battery, a nickel-metal hydride (NiMH) battery, and a lithium (Li) battery, and an alternating current (AC) adapter.

A recording medium I/F 18 is an interface with the recording medium 200, such as a memory card or a hard disk. One example of the recording medium 200 is a memory card for recording captured images, such as a semiconductor memory or a magnetic disk.

A communication unit 54 transmits and receives video signals and audio signals to and from an external device connected via a wireless or wired communication. The communication unit 54 is also connectable to a wireless local area network (LAN) and the Internet. The communication unit 54 can also communicate with an external device via Bluetooth® or Bluetooth Low Energy. The communication unit 54 can transmit images (including LV images) captured by the image capturing unit 22 and images recorded in the recording medium 200 and can receive image data and a variety of other information from an external device.

An orientation detection unit 55 detects the orientation of the digital camera 100 with respect to the direction of gravitational force. A determination can be made whether an image captured by the image capturing unit 22 is an image captured with the digital camera 100 laterally held or vertically held based on the orientation detected by the orientation detection unit 55. A system control unit 50 is capable of adding orientation information corresponding to the orientation detected by the orientation detection unit 55 to the image file of images captured by the image capturing unit 22 and recording the images in a rotated orientation. Examples of the orientation detection unit 55 include an acceleration sensor and a gyro sensor. By using the acceleration sensor or the gyro sensor serving as the orientation detection unit 55, the movement (pan, tilt, lift, remaining still, or the like) of the digital camera 100 can be detected.

The eye detection unit 57 is an eye detection sensor for detecting the approach (eye contact) and separation (eye receding) of the eye (object) 161 with respect to the eyepiece 16 of the eyepiece viewfinder (hereinafter referred to as “viewfinder”). The system control unit 50 switches between display (displayed state) and non-display (non-displayed state) of the display unit 28 and the EVF 29 in accordance with a state detected by the eye detection unit 57. More specifically, in a case where the system is at least in an image capturing standby state and the display destination is switched automatically, the display destination is set to the display unit 28 and the EVF 29 is disabled during a non-eye-contact state. During an eye-contact state, the display destination is set to the EVF 29, and the display unit 28 is disabled. One example of the eye detection unit 57 is an infrared proximity sensor, which is capable of detecting the approach of an object to the eyepiece 16 of the viewfinder that houses the EVF 29. When an object approaches, infrared light emitted from a light emitter (not shown) of the eye detection unit 57 is reflected by the object and received by a light receiver (not shown) of the infrared proximity sensor. The distance from the object to the eyepiece 16 (eye approach distance) can also be determined based on the amount of received infrared light. In this manner, the eye detection unit 57 performs eye approach detection to detect a proximity distance to the eyepiece 16 from the object. When an object is detected as having approached the eyepiece 16 within a predetermined distance from a non-eye-contact state (non-approach state), the eye detection unit 57 determines that eye approach has been established. When an object whose proximity has been detected moves away by a predetermined distance or more from an eye-contact state (approach state), the eye detection unit 57 determines that eye separation has occurred. A threshold for detecting eye contact and a threshold for detecting eye separation may be different, for example, by setting a hysteresis. Once eye contact is detected, the system is considered to remain in the eye-contact state until eye separation is detected. Once eye separation is detected, the system is considered to remain in the non-eye-contact state until eye contact is detected. The infrared proximity sensor is merely one example; the eye detection unit 57 may be any other sensor that can detect the approach of an eye or object that can be regarded as eye contact.

The system control unit 50 is capable of detecting the following states of gaze at the EVF 29 by controlling the gaze detection unit 160.
A state in which a gaze that has not been directed to the EVF 29 is newly directed to the EVF 29. In other words, a gaze input is started.
A state in which a gaze is being input to the EVF 29.
A state in which a certain position of the EVF 29 is being gazed at.
A state in which a gaze at the EVF 29 is removed. In other words, a state in which a gaze input ends.
A state in which no gaze is input to the EVF 29 (a state in which the EVF 29 is not looked at).

Such operations and states and the position (direction) of the gaze at the EVF 29 are sent to the system control unit 50 via an internal bus. The system control unit 50 determines how the gaze input is being performed based on the sent information.

The operating unit 70 is a reception unit that receives operations from the user (user operations) and is used to input various kinds of operation instructions to the system control unit 50. As illustrated in FIG. 2, the operating unit 70 includes a mode changeover switch 60, a shutter button 61, a power switch 72, and a touch panel 70a. The operating unit 70 further includes, as other operation members 70b, the main electronic dial 71, the sub-electronic dial 73, the four-way key 74, the set button 75, the video button 76, the AE lock button 77, the zoom button 78, the playback button 79, the menu button 81, and the MC 65.

The mode changeover switch 60 is an operation member for switching between image capturing modes. Examples of the image capturing modes include a full automatic image capturing mode (scene intelligent auto) and a flexible AE image capturing mode (Fv mode). Other examples of the image capturing mode include a manual exposure mode (M mode), an aperture-priority AE mode (Av mode), a shutter-priority AE mode (Tv mode), and a program AE image capturing mode (P mode). Still other examples include a special scene mode (SCN mode) and a custom mode for automatically capturing images in an image capturing mode selected by the user according to the subject or scene.

The mode changeover switch 60 allows the user to directly switch between these modes. Alternatively, after the image capturing mode list screen is once switched to by the mode changeover switch 60, it is also possible to selectively switch to one of the plurality of displayed modes using a different operation member.

The shutter button 61 includes a first shutter switch 62 and a second shutter switch 64. The first shutter switch 62 is turned on during an operation on the shutter button 61, that is, by half press (an instruction to prepare image capturing), to generate a first shutter switch signal SW1. In response to the first shutter switch signal SW1, the system control unit 50 starts an image capturing preparation process, such as an AF process, an AE process, an AWB process, and an EF process. The second shutter switch 64 is turned on when an operation on the shutter button 61 is completed, that is, by full press (an instruction to perform image capturing), to generate a second shutter switch signal SW2. In response to the second shutter switch signal SW2, the system control unit 50 starts a series of image capturing operations from reading a signal from the image capturing unit 22 to writing a captured image to the recording medium 200 as an image file.

The touch panel 70a and the display unit 28 may be integrally configured. For example, the touch panel 70a is configured to have a light transmittance that does not interfere with the display of the display unit 28 and mounted on the upper layer of the display surface of the display unit 28. The input coordinates on the touch panel 70a are associated with the display coordinates on the display surface of the display unit 28. This allows a graphical user interface (GUI) to be provided that gives the appearance that the user can directly operate the screen displayed on the display unit 28. The system control unit 50 can detect the following operations on the touch panel 70a or states.
An operation in which a finger or a pen, which has not been touching the touch panel 70a, newly comes into contact with the touch panel 70a, i.e., the start of a touch (hereinafter referred to as “touch-down”).
A state in which the touch panel 70a is touched by a finger or a pen (hereinafter referred to as “touch-on”.
An operation in which a finger or a pen is moving while touching the touch panel 70a (hereinafter referred to as “touch-move)”.
An operation in which a finger or a pen, which has been touching the touch panel 70a, has been separated (released) from the touch panel 70a, i.e., the end of the touch (hereinafter referred to as “touch-up)”.
A state in which nothing is touching the touch panel 70a (hereinafter referred to as “touch-off”.

When a touch-down is detected, touch-on is also detected simultaneously. After the touch-down, a touch-on is normally detected continuously unless a touch-up is detected. Even when a touch-move is detected, a touch-on is simultaneously detected. Even when a touch-on is detected, a touch-move is not detected unless a touch position is moved. After the touch-up of all of the fingers or pens that have been touching is detected, the system enters a touch-off.

These operations and states and the position coordinates of the finger or a pen that are touching the touch panel 70a are sent to the system control unit 50 via an internal bus. The system control unit 50 determines what kind of operation (touch operation) has been performed on the touch panel 70a based on the sent information.

For the touch-move, the moving direction of the finger or a pen that is moving on the touch panel 70a can also be determined based on a change in the position coordinates for each vertical component and horizontal component on the touch panel 70a. When a touch-move of a predetermined distance or more is detected, it is determined that a sliding operation has been performed.

An operation in which a finger is quickly moved over a certain distance, with the finger kept in contact with the touch panel 70a, and then lifted off is referred to as a flick. In other words, the flick is an operation in which a finger is quickly slid across the touch panel 70a in a flicking motion. When a touch-move operation performed at a predetermined speed or more for a predetermined distance or more is detected, and thereafter a touch-up is detected, it can be determined that a flick has been performed (it can be determined that a flick has occurred after a sliding operation).

A touch operation in which multiple positions (for example, two points) are touched (multi-touched) to bring the touch positions close to each other is referred to as “pinch-in”, and a touch operation in which the touch positions are separated is referred to as “pinch-out”. The pinch-out and the pinch-in are collectively referred to as a pinch operation (or simply referred to as “pinch”).

The touch panel 70a may be of any type, such as a resistive film method, a capacitive method, a surface acoustic wave method, an infrared light method, an electromagnetic induction method, an image recognition method, or an optical sensor method. Examples of touch detection methods include a method of detecting a touch based on contact with a touch panel and a method of detecting a touch based on the approach of a finger or a pen to the touch panel, any of which may be employed.

The digital camera 100 may be provided with a voice input unit (not shown) that transmits voice, obtained from a built-in microphone or a voice input device connected via a voice input terminal, to the system control unit 50. In this case, the system control unit 50 selects the input voice signal as needed, performs analog-to-digital conversion, applies level adjustment processing, specific frequency reduction processing, and the like, and generates a voice signal.

In the present embodiment, the user can set a method for designating the position of a position indicator (for example, an AF frame) when performing a touch-move operation in an eye-contact state to either an absolute-position designation method or a relative-position designation method.

The absolute-position designation method is a method in which the input coordinates on the touch panel 70a are associated with the display coordinates on the display surface of the EVF 29. In the case of the absolute-position designation method, when a touch-down operation is performed on the touch panel 70a, an AF frame is displayed at a position associated with the touched position (the position at which the coordinates are input) (the AF frame moves from the position before the touch-down) even if a touch-move is not performed. The position displayed using the absolute-position designation method is a position based on the touch-down position regardless of the position before the touch-down. When a touch-move is performed after the touch-down, the position of the AF frame is also moved based on the touch position after the touch-move.

The relative-position designation method is a method in which the input coordinates on the touch panel 70a are not associated with the display coordinates on the display surface of the EVF 29. In the case of the relative-position designation method, when a touch-down occurs on the touch panel 70a without any touch-move, the position of the AF frame does not change from the position before the touch-down. When a touch-move occurs thereafter, the position of the AF frame changes from the position of the current AF frame (the position set before the touch-down) by a distance corresponding to the amount of movement of the touch-move in the direction of movement of the touch-move regardless of the position of the touch-down.

One of a plurality of AF methods including “single-point AF” and “entire-area AF” is configurable as an AF area (a setting method for the AF frame). Furthermore, whether to perform subject detection setting (tracking) is configurable.

The “single-point AF” is a method in which the user designates a single location as a position for AF using a single-point AF frame. The “entire-area AF” is a method in which, when no tracking target is designated by the user, an AF position is automatically set based on automatic selection conditions. A tracking setting can be reflected in combination with such an AF area setting. When tracking is set to “ON” and a human face is detected from the LV image, the system enters a mode in which the detected face is preferentially tracked as an AF target. When a plurality of human faces is detected, one face is selected according to priority conditions such as the size of the face being large, the position of the face being close to the digital camera 100 (i.e., on the near side), the position of the face being near the center of the image, or the face being the face of a pre-registered person, and set as an AF target. When no human face is detected, a subject other than a face is selected according to priority conditions such as the subject being close to the digital camera 100 (i.e., on the near side), the subject having high contrast, the subject having high priority such as an animal or vehicle, or the subject being a moving object, and set as an AF target. When a tracking target is designated by the user, the tracking target is set as an AF target. In other words, the automatic selection conditions are such that scores obtained by performing weighting using at least one of factor conditions as exemplified below are either equal to or greater than a predetermined threshold or the highest among all candidates.
The face is the detected human face.
The size of the face is large.
The position of the face is close to the digital camera 100 (i.e., on the near side).
The position of the face is near the center of the image.
The face is the face of a pre-registered person.
The subject is close to the digital camera 100 (i.e., on the near side).
The subject has high contrast.
The subject has high priority such as an animal or vehicle.
The subject is a moving object.

### Flowchart for Processing in Image Capturing Mode

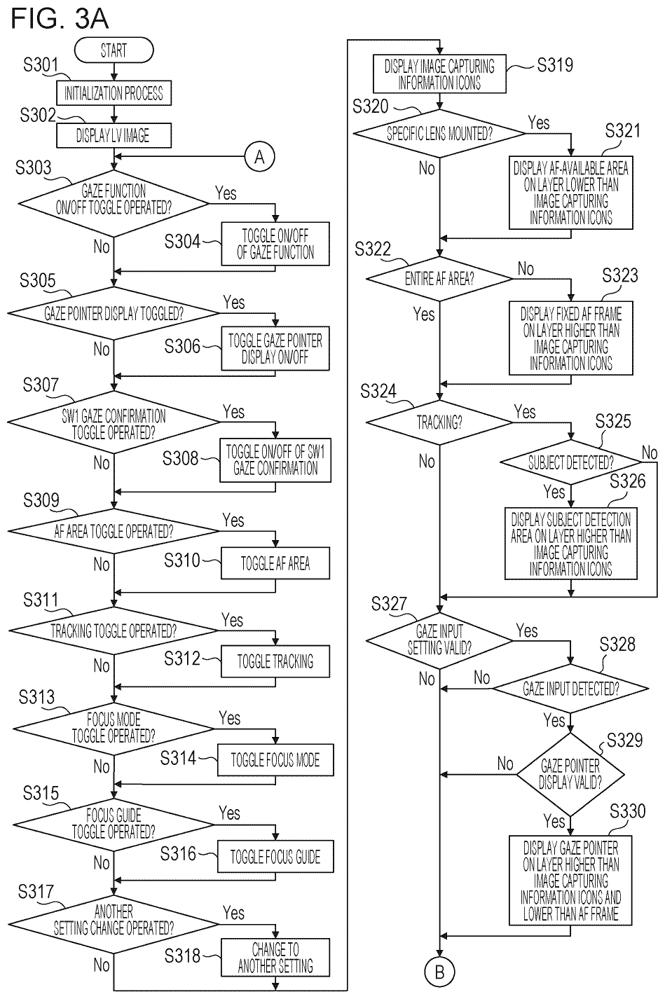

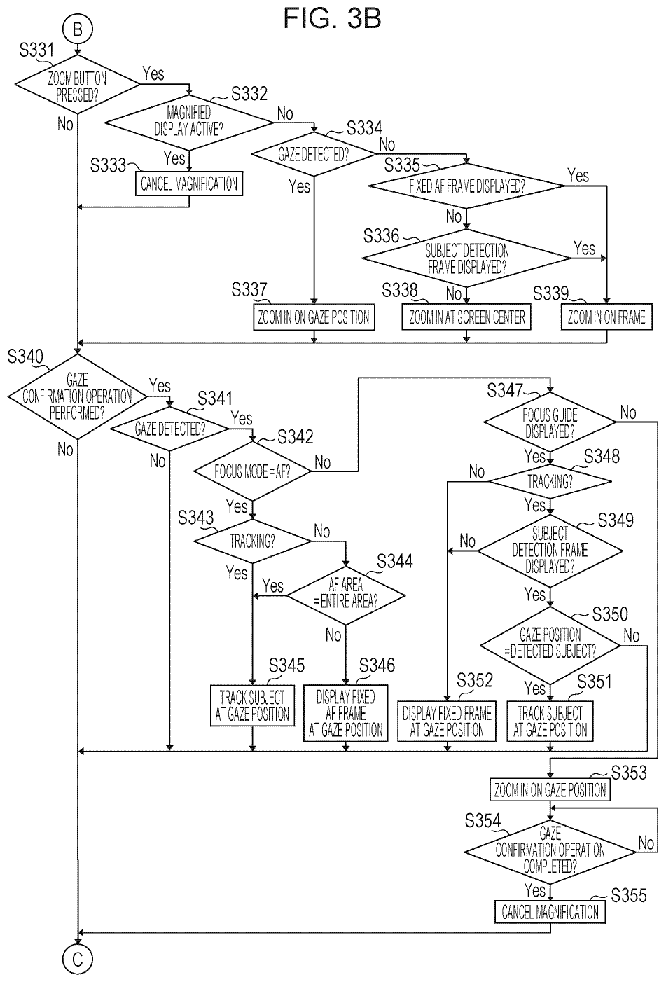

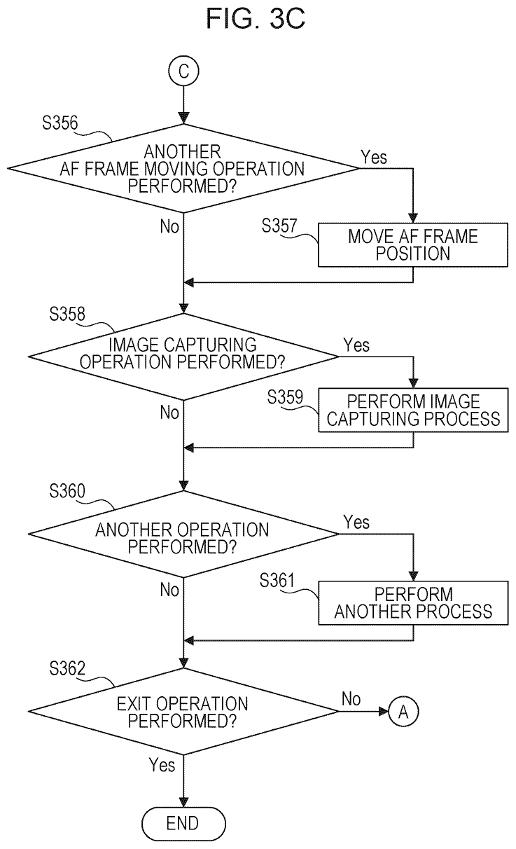

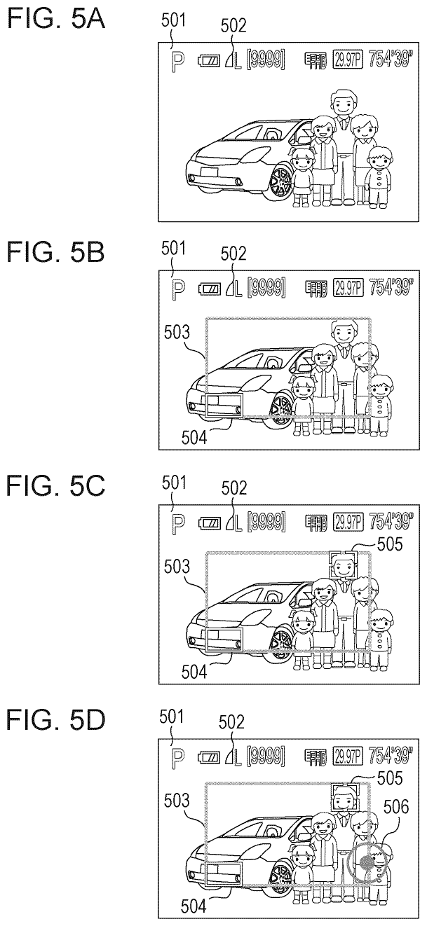

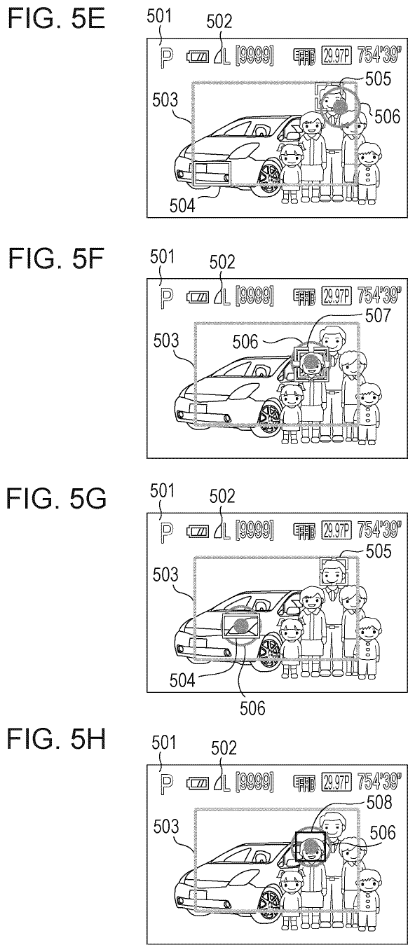

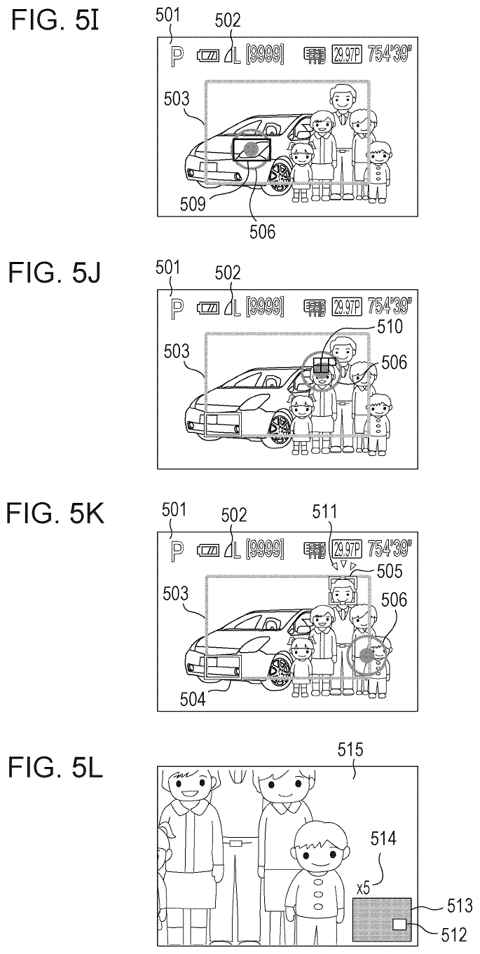

FIGS. 3A to 3C are flowcharts illustrating processing in an image capturing mode of the digital camera 100, which is an example of the image capturing apparatus according to the first embodiment. This processing is implemented by the system control unit 50 executing a program stored in the non-volatile memory 56 and loaded into the system memory 52. This processing is executed until the image capturing mode ends or the power source of the image capturing apparatus is turned off. In other words, the processing is repeated while the image capturing mode continues. When the digital camera 100 is activated in the image capturing mode, flags, control variables, and the like are initialized, and the processing is started. FIGS. 5A to 5L illustrate examples in which an LV image is displayed on the screen of the digital camera 100, which is an example of the image capturing apparatus according to the first embodiment, in the image capturing mode.

In S301, the system control unit 50 initializes flags, control variables, and the like.

In S302, the system control unit 50 instructs the display unit 28 to display an LV image 501 in response to a signal detected by the image capturing unit 22, as illustrated in FIG. 5A.

In S303, the system control unit 50 determines whether a switching operation for determining whether to execute a process based on gaze input has been performed on the operating unit 70. If the operation has been performed, the process proceeds to S304; otherwise, the process proceeds to S305.

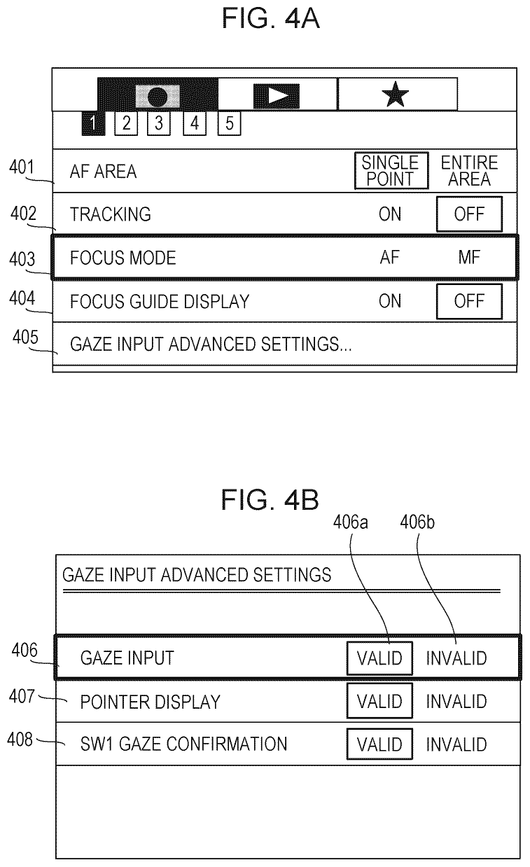

FIGS. 4A and 4B illustrate display examples of a menu screen in which various settings of the digital camera 100, which is an example of the image capturing apparatus according to the first embodiment, are switched. AF area setting 401 in FIG. 4A is an item that allows selection of an AF area, either a single-point or an entire-area. Tracking 402 is an item for determining whether to track the subject. Focus mode 403 is an item that allows selection of either a mode in which the digital camera 100 automatically adjusts focus (AF mode) or a mode in which the user manually adjusts focus (MF mode). Focus guide display 404 is an item for determining whether to display a focus guide, described later.

In the first embodiment, the AF mode or the MF mode is selected via a menu screen displayed on the digital camera 100 body; alternatively, the AF mode or the MF mode may be selected using a focus mode switch provided on the lens unit 150. The focus mode switch is a switch that allows manual switching between the MF mode and the AF mode.

When Gaze AF advanced settings 405 in FIG. 4A is selected, the screen transitions to a gaze input advanced settings screen in FIG. 4B. Gaze input 406 in FIG. 4B is an item for determining whether to execute processing based on gaze input. Pointer display 407 is an item for determining whether to display a gaze pointer at a position based on the gaze position. SW1 gaze confirmation 408 is an item for determining whether to perform a gaze confirmation operation via the first shutter button 62.

In S304, the system control unit 50 switches between Valid 406a and Invalid 406b of Gaze input 406 in accordance with an operation.

In S305, the system control unit 50 determines whether a switching operation for determining whether to display a gaze pointer at a gaze position based on the detected gaze has been performed on the operating unit 70. If the operation has been performed, the process proceeds to S306; otherwise, the process proceeds to S307.

In S306, the system control unit 50 switches between Valid and Invalid of Gaze pointer display 407 in accordance with an operation.

In S307, the system control unit 50 determines whether a switching operation for determining whether to perform a gaze confirmation operation via the first shutter button (SW1) 62 has been performed on the operating unit 70. If the operation has been performed, the process proceeds to S308; otherwise, the process proceeds to S309.

In S308, the system control unit 50 switches between Valid and Invalid of SW1 gaze confirmation 408 in accordance with an operation.

In S309, the system control unit 50 determines whether a switching operation for setting an AF area to single-point or entire-area has been performed on the operating unit 70. If the operation has been performed, the process proceeds to S310; otherwise, the process proceeds to S311.

In S310, the system control unit 50 switches between single-point and entire-area in AF area setting 401 in accordance with an operation.

In S311, the system control unit 50 determines whether a switching operation for determining whether to track a subject has been performed on the operating unit 70. If the operation has been performed, the process proceeds to S312; otherwise, the process proceeds to S313.

In S312, the system control unit 50 switches between Yes and No in Tracking 402.

In S313, the system control unit 50 determines whether a switching operation for setting the focus mode to AF mode or MF mode has been performed on the operating unit 70. If the operation has been performed, the process proceeds to S314; otherwise, the process proceeds to S315.

In S314, the system control unit 50 switches between AF and in MF focus mode 403 in accordance with an operation.

In S315, the system control unit 50 determines whether a switching operation for determining whether to display a focus guide is performed on the operating unit 70. If the operation has been performed, the process proceeds to S316; otherwise, the process proceeds to S317.

In S316, the system control unit 50 switches between Yes and No in Focus guide display 404 in accordance with an operation. The focus guide is displayed to assist the user to manually adjust focus in the MF mode and indicates the direction and amount of adjustment from the current position of the focus target to an in-focus position.

FIG. 5K is a display example of the focus guide on an LV image. A subject detection frame 505 is superimposed on the LV image 501 at the position of the detected subject. A focus guide 511 is displayed in the vicinity of the subject detection frame 505. The direction and amount of adjustment from the current position to the in-focus position are indicated by changing the display format of the focus guide 511. Whether the detected subject is in focus or not is indicated by changing the color of the focus guide 511.

In S317, the system control unit 50 determines whether a switching operation for another setting has been performed on the operating unit 70. If the operation has been performed, the process proceeds to S318; otherwise, the process proceeds to S319.

In S318, the system control unit 50 switches another setting in accordance with an operation. The “another setting” includes, for example, a setting for function assignment that is activated when the MC 65 is pressed.

In S319, the system control unit 50 superimposes various setting values related to the processing in the image capturing mode on the LV image 501 as image capturing information icons 502. FIG. 5A illustrates a display example of the image capturing information icons 502 on the LV image 501.

In S320, the system control unit 50 determines whether a specific lens is mounted. The specific lens is, for example, a lens whose AF range is smaller than normal. For such a lens, it is necessary to indicate, to the user via a GUI or the like, the range within the displayed LV image in which AF is available. If a specific lens is mounted, the process proceeds to S321; otherwise, the process proceeds to S322.

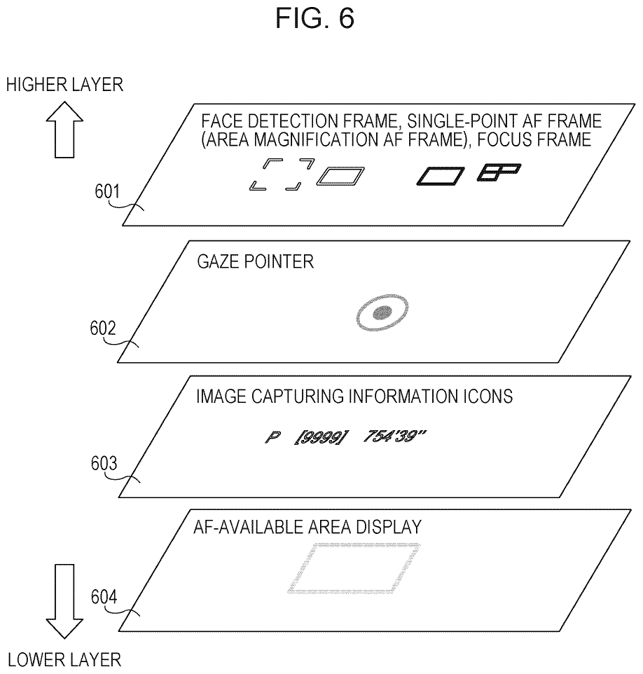

In S321, the system control unit 50 superimposes the image capturing information icons 502 on the displayed LV image 501 and displays an AF-available area 503, as illustrated in FIG. 5B. At that time, the AF-available area 503 is displayed on a layer 604 lower than a layer 603 on which the image capturing information icons 502 are displayed, as in the schematic diagram of FIG. 6 that illustrates the display layers of the GUI components of the digital camera 100.

In S322, the system control unit 50 determines whether AF area is set to “Entire-area”. If AF area is set to “Entire-area”, the process proceeds to S324; otherwise, the process proceeds to S323.

In S323, the system control unit 50 superimposes a fixed AF frame 504 having a size corresponding to the current setting for AF area on the LV image 501, as illustrated in FIG. 5B. At that time, the fixed AF frame 504 is displayed on a layer 601 higher than the layer 603 on which the image capturing information icons 502 are displayed and a layer 602 on which a gaze pointer, described later, is displayed, as illustrated in FIG. 6.

In S324, the system control unit 50 determines whether to perform tracking. If tracking is to be performed, the process proceeds to S325; otherwise, the process proceeds to S327.

In S325, the system control unit 50 determines whether a subject has been detected on the LV image. If a subject is detected, the process proceeds to S326; otherwise, the process proceeds to S327.

In S326, the system control unit 50 superimposes the subject detection frame 505 on the detected subject in the LV image 501, as illustrated in FIG. 5C. The subject detection frame 505 is displayed on the layer 601, as is the fixed AF frame 504, as illustrated in FIG. 6.

In S327, the system control unit 50 determines whether to execute processing based on gaze input. If the gaze input is valid, the process proceeds to S328; otherwise, the process proceeds to S331.

In S328, the system control unit 50 determines whether a gaze input has been detected. If a gaze input is detected, the process proceeds to S329; otherwise, to S331.

In S329, the system control unit 50 determines whether Gaze pointer display is valid. If it is valid; the process proceeds to S330; otherwise, to S331.

In S330, the system control unit 50 displays a gaze pointer 506 at a gaze position based on a detected gaze, as illustrated in FIG. 5D. At that time, the gaze pointer 506 is superimposed on the LV image 501. The gaze pointer 506 is displayed on a layer 602 higher than the layer 603 on which the image capturing information icons 502 are displayed and the layer 604 on which the AF-available area 503 is displayed and lower than the layer 601 on which various AF frames are displayed, as illustrated in FIG. 6. FIG. 5E is a display example in which the gaze pointer 506 and the subject detection frame 505 are displayed at close positions.

In S331, the system control unit 50 determines whether an operation on the zoom button 78 of the operating unit 70 has been performed. If the operation is performed, the process proceeds to S332; otherwise, the process proceeds to S340. When the zoom button 78 is pressed, partial magnification of the LV image or cancellation of the magnification is executed. If the LV image is not displayed in a magnified manner, magnified display of the LV image is executed in response to an operation on the zoom button 78. If the LV image is displayed in a magnified manner, magnified display of the LV image is cancelled, and returns to normal LV display in response to an operation on the zoom button 78. In the present embodiment, the system alternately performs LV magnified display and cancellation of the LV magnified display in response to a press of the zoom button 78. However, it is also possible to sequentially switch the display among an LV image magnified display (× 5), LV magnified image display (× 10), and cancellation of the LV magnified display in response to successive presses of the zoom button 78, thereby toggling multiple magnification levels and cancellation of magnification in order.

In S332, the system control unit 50 determines whether the LV image is displayed in a magnified manner. If an LV image is displayed in a magnified manner, the process proceeds to S333; otherwise, the process proceeds to S334.

In S333, the system control unit 50 cancels the magnified display of the LV image in response to a user's instruction.

In S334, the system control unit 50 determines whether a user's gaze at the display unit 28 is detected by switching between Valid 406a and Invalid 406b of Gaze input 406 in S303. If a user's gaze is detected, the process proceeds to S337; otherwise, the process proceeds to S335.

In S335, the system control unit 50 determines whether the fixed AF frame 504 is displayed on the LV image. If the fixed AF frame 504 is displayed, the process proceeds to S339; otherwise, the process proceeds to S336.

In S336, the system control unit 50 determines whether the subject detection frame 505 is displayed on the LV image. If the subject detection frame 505 is displayed, the process proceeds to S339; otherwise, the process proceeds to S338.

In S337, the system control unit 50 displays the LV image in a magnified manner at a gaze position based on the user's gaze. FIG. 5L illustrates an example in which the LV image is magnified at the gaze position and displayed full-screen, and the LV image is magnified based on the position of the gaze pointer 506 in FIG. 5K. A magnification range 512, a range 513 indicating the entire screen, and a magnification level 514 are superimposed on the magnified LV image 515. The gaze pointer 506 is not displayed during execution of magnified display on the assumption that the magnification position is moved or a subject is designated via an operation member. However, even during magnified display, movement of the magnification position, designation of the subject, and other operations may be performed based on a gaze. In the magnified LV image 515, a target focus position can be specified with high precision. This allows the user to perform manual focusing while accurately confirming the subject to be focused.

A gaze may be utilized as a unit configured to cancel a state in which the LV image 515 is displayed (in a magnified manner). For example, when a user gazes at a predetermined area at an end of the LV image 515, it may be determined that the user wishes to view an LV image outside the range of the LV image 515 and may cancel the magnified display. A specific GUI object may be superimposed on the LV image 515, and when a gaze on the object is detected, the magnified display may be cancelled.

In S338, the system control unit 50 magnifies the LV image based on the central position of the screen.

In S339, the system control unit 50 magnifies the LV image based on the position of the fixed AF frame 504, or the subject detection frame 505. When the focus guide 511 is displayed, the subject detection frame 505 is also displayed. Therefore, the LV image is magnified based on the position of the subject detection frame 505. Even when the focus guide 511 is not displayed, the LV image is magnified based on the position of the subject detection frame 505, if the subject detection frame 505 is displayed.

In S340, the system control unit 50 determines whether an operation for confirming the gaze position has been performed on the operating unit 70. If a gaze confirmation operation has been performed, the process proceeds to S341; otherwise, the process proceeds to S356. The gaze confirmation operation in S340 is executed by pressing the AF-ON button 82. The gaze confirmation function may be assigned to a different button other than the AF-ON button. For example, the gaze confirmation function may be assigned to the first shutter button 62 or the like, and a gaze position may be confirmed by a half-press of the first shutter button 62. If the system control unit 50 determines that SW1 gaze confirmation 408 on the gaze AF advanced settings screen in FIG. 4B has been switched to Valid (S308), the gaze confirmation function is assigned to the first shutter button 62.

In S341, the system control unit 50 determines whether a user's gaze at the display unit 28 has been detected based on the switching between Valid 406a and Invalid 406b in Gaze input 406 in S303. If the gaze is detected, the process proceeds to S342; otherwise, the process proceeds to S356.

In S342, the system control unit 50 determines whether the focus mode is the AF mode based on Focus mode 403 switched by the user in S313. If the focus mode is the AF mode, the process proceeds to S343; if the focus mode is the MF mode, the process proceeds to S347.

In S343, the system control unit 50 determines whether to perform tracking based on Tracking 402 switched by the user in S311. If tracking is to be performed, the process proceeds to S345; otherwise, the process proceeds to S344.

In S344, the system control unit 50 determines whether the AF area is set over the entire area based on AF area 401 switched by the user in S309. If the AF area is set over the entire area, the process proceeds to S345; otherwise, the process proceeds to S346.

In S345, the system control unit 50 tracks a subject located at a gaze position based on the user's gaze. FIG. 5F illustrates a display example of the LV image in which the subject is being tracked. A tracking frame 507 is superimposed on the LV image 501 at a gaze position based on the detected gaze. The tracking frame 507 is displayed, as is the fixed AF frame 504, on the layer 601 illustrated in FIG. 6.

In S346, the system control unit 50 displays the fixed AF frame 504 at a gaze position based on the user's gaze.

In S347, the system control unit 50 determines whether the focus guide 511 is displayed on the LV image based on Focus guide display 404 switched by the user in S315. If the focus guide 511 is displayed, the process proceeds to S348; otherwise, the process proceeds to S353.

In S348, the system control unit 50 determines whether to perform tracking based on Tracking 402 switched by the user in S311. If tracking is to be performed, the process proceeds to S349; otherwise, the process proceeds to S352.

In S349, the system control unit 50 determines whether the subject detection frame 505 is displayed on the LV image. If the focus guide 511 is displayed on the LV image, the subject detection frame 505 is also displayed. If the subject detection frame 505 is displayed, the process proceeds to $350; otherwise, the process proceeds to S352.

In S350, the system control unit 50 determines whether the gaze position based on the user's gaze is in the vicinity of the subject detection frame 505. If the gaze position is in the vicinity, the process proceeds to S351; otherwise, the process proceeds to S356. The definition of the vicinity for proceeding to S351 may vary depending on the camera settings or conditions.

In S351, the system control unit 50 displays the tracking frame 507 at a gaze position based on the user's gaze and tracks the subject.

In S352, the system control unit 50 displays a fixed frame at the gaze position based on the user's gaze.

In S353, the system control unit 50 magnifies the LV image at a gaze position based on the user's gaze.

In S354, the system control unit 50 determines whether the gaze confirmation operation has been completed. If the gaze confirmation operation has been completed, the process proceeds to S355; otherwise, the process proceeds to S354. The magnified display of the LV image at the gaze position in S331 is executed in response to a press of the zoom button 78. In this case, the system control unit 50 controls the display such that the magnified state is maintained even after the press of the zoom button has ended, unless an instruction from the user is given. In contrast, the magnified display of the LV image at the gaze position in S353 is executed in response to a gaze confirmation operation. In this case, if in S354 the system control unit 50 determines that the gaze confirmation operation has ended, then in S355 the system control unit 50 controls the display such that the magnified display of the LV image is cancelled. In this manner, when the LV image is magnified in response to the gaze confirmation operation, the system control unit 50 controls the display such that the LV image is temporarily magnified. Therefore, when the LV image is magnified in response to, not a press of the zoom button, but a gaze confirmation operation, the user can quickly transition to a focusing operation.

In S356, the system control unit 50 determines whether another AF frame moving operation has been performed on the operating unit 70. If the operation has been performed, the process proceeds to S357; otherwise, the process proceeds to S358. Examples of the AF frame moving operation include an operation of pressing the MC 65 in eight directions and an operation of pressing the center to returning the AF frame to the screen center.

In S357, the system control unit 50 moves the AF frame in response to an operation.

In S358, the system control unit 50 determines whether an image capturing operation has been performed on the operating unit 70. If the operation has been performed, the process proceeds to S359; otherwise, the process proceeds to S360.

In S359, the system control unit 50 performs an image capturing process.

In S360, the system control unit 50 determines whether another operation has been performed on the operating unit 70. If another operation has been performed, the process proceeds to S361; otherwise, the process proceeds to S362. Examples of another operation include operations for changing various parameters (shutter speed, an f-number, and the like).

In S361, the system control unit 50 performs another process.

In S362, the system control unit 50 determines whether an exit operation has been performed on the operating unit 70. If the process has been performed, the processing is completed; otherwise, the process proceeds to S303.

The AF-ON button 82 may include a first switch and a second switch, similarly to the shutter button 61. A switching signal may be generated such that a first function is activated in response to a so-called half-press operation in the middle of pressing each button, and a second function is activated in response to a so-called full-press operation. The first function and the second function may include, for example, confirmation of a gaze position, AE lock, magnification of an LV image, instruction to perform image capturing, and instruction to execute AF. It is also possible to provide a means that enables the user to freely assign these functions. For example, the first function may be assigned an operation for magnifying an LV image by a predetermined magnification, and the second function may be assigned an operation for magnifying an LV image by a magnification higher than the predetermined magnification. This allows quick toggling among multiple magnification levels. By assigning magnification of an LV image to the first function and assigning confirmation of a gaze position to the second function, it becomes possible to magnify the LV image and designate a more accurate position based on gaze input. Focus mode settings may be included in the image capturing information icon 502.

In this manner, the system control unit 50 controls the operation such that different operations are executed in response to the same gaze confirmation operation by the user: in the AF mode, the gaze position is selected as a process execution position, and in the MF mode, a magnified display is provided at the gaze position.

Directly after a GUI component such as the fixed AF frame 504 is displayed at the position of the gaze pointer 506 based on a gaze confirmation operation, the gaze pointer 506 may be hidden for a predetermined period. This may make it easier to visually identify a GUI component such as the fixed AF frame 504 directly after the confirmation operation.

AF operation settings may allow switching between one-shot AF and servo AF. In one-shot AF, control of the display layer, described above, may be performed, whereas in servo AF, such control may not be performed. This is because, when serve AF is set, the shooting scene involves a moving subject, and the positions of the gaze pointer 506 and the tracking frame 507 constantly move, and therefore, it is expected that they rarely overlap.

An AF result frame 508 may be displayed by changing the display form of the subject detection frame 505 or the tracking frame 507 (FIG. 5H). The AF result frame 508 represents the result of AF processing by changing the color from the subject detection frame 505 or the tracking frame 507, but another display form may be used. An AF result frame 509 may be displayed by changing the display form of the fixed AF frame 504 (FIG. 5I). The AF result frame 509 represents the result of AF processing by changing the color from the fixed AF frame 504, but another display form may be used. When the tracking setting is disabled, or when the setting is such that subject tracking is not performed by gaze confirmation (for example, executing AF on a nearby subject), the position of the AF target may be set to the entire area, and a display form such as a multi-point AF frame 510 may be used (FIG. 5J).

### Second Embodiment

In the first embodiment, when a gaze confirmation operation is performed, a user's gaze is detected, the focus mode is the MF mode, and the focus guide is not displayed, the system control unit 50 perform magnified display of an LV image at a gaze position. In a second embodiment, in such a case, the system control unit 50 performs peaking display by emphasizing an in-focus portion of the subject within a predetermined range from a position based on the gaze position.

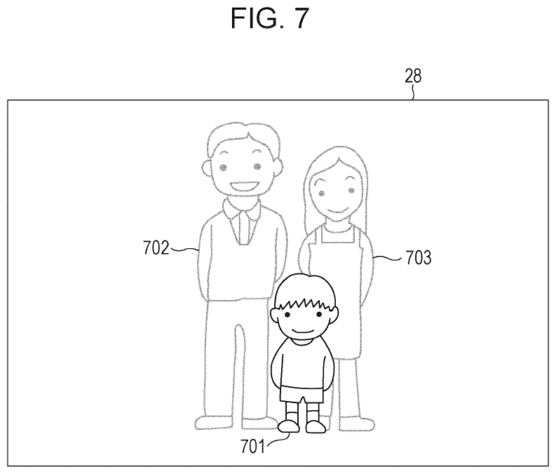

FIG. 7 is a diagram illustrating an example in which an in-focus state is displayed on the display unit 28 of the digital camera 100, which is an example of an image capturing apparatus according to a second embodiment. Among a child 701, a father 702, and a mother 703, the child 701 is in focus. The edge of the child 701 is prominently displayed, whereas the edges of the father 702 and the mother 703, who are not in focus, are faintly displayed, thereby emphasizing the edge of the child 701. Thus, even when a plurality of subjects is captured, the subject that is in focus is displayed, making it easier for the user to manually focus on a desired subject even in the MF mode.

In the first and second embodiments, an example in which the present disclosure is applied to a digital camera has been described. However, the present disclosure can be applied in situations where quick and accurate selection of a subject or a designated target is required.

### Third Embodiment

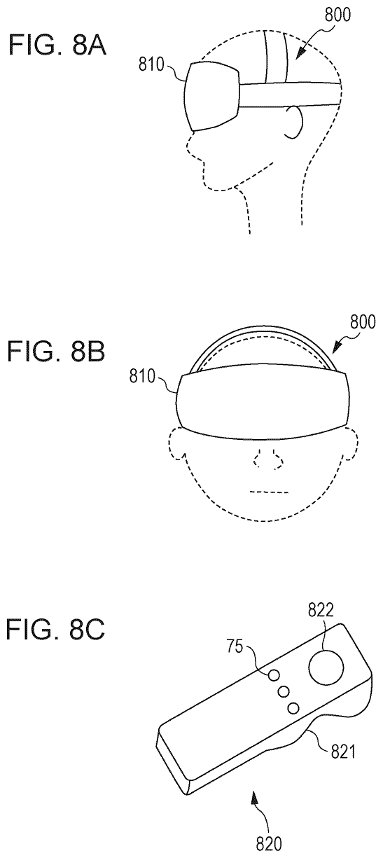

FIGS. 8A and 8B are external views of a head set including a head mount display (HMD) 810 according to a third embodiment. FIG. 8C is an external view of a game controller 820 serving as an operation member according to the third embodiment. The third embodiment assumes that a user who wears this head set is playing an action game. When a virtual game character or the like is displayed on a virtual reality (VR) image on the HMD, the user can quickly select the target of attack or accurately determine the target of attack by magnifying the image based on a user's gaze confirmation operation.

FIGS. 8A and 8B are external views of a head set 800. The head set 800 is mainly constituted by an HMD 810. The HMD 810 is a VR device that can be used alone (stand-alone VR-HMD) without being connected to a personal computer (PC) or the like. The HMD 810 incorporates a system control unit, a gaze detection unit, and other components necessary for implementing the present embodiment.

FIG. 8C is an external view of a game controller 820. The game controller 820 receives instructions for displaying a game screen 900 (described later) displayed on the HMD 810 and performs related operations. The game controller 820 includes a grip portion 821, a multi-button 822, which is a depressible operation member including a touchable portion, and set buttons 75. The grip portion 821 is structured and made of a material to allow the user to easily hold the game controller 820, similarly to the grip portion 90 of the digital camera 100. The multi-button 822 may be assigned various functions such as a function for providing an instruction to move a pointer displayed on a game screen 900 (described later).

The multi-button 822 is an operation member capable of receiving both a touch operation and a depression operation. A touch operation member mounted on the multi-button 822 may be a touch detection mechanism, as described above, or an infrared sensor. The infrared sensor is disposed in the multi-button 822 and applies infrared light to the top of the multi-button 822 (a portion with which a user's finger comes into contact). When a user comes into contact with the top of the multi-button 822, infrared light is reflected by the user's finger. By detecting this reflected light, the movement of the user's finger can be detected. Such an optical operation member is referred to as an optical tracking pointer (OTP). The OTP can detect a moving operation, which is the movement of a user's finger (operating member) with respect to the OTP, similarly to the touch panel 70a. The multi-button 822 is not limited to the OTP and may be a direction indicator member such as the MC 65, the four-way key 74, or a joystick. The HMD 810 and the game controller 820 may be connected via wire or a wireless communication such as Bluetooth.

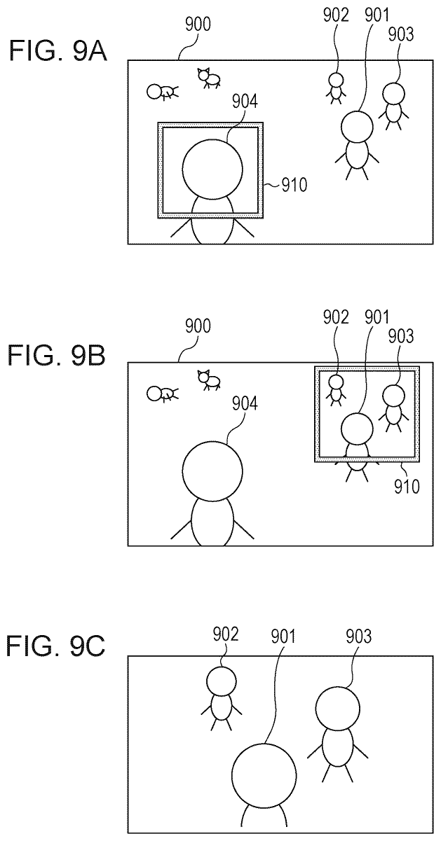

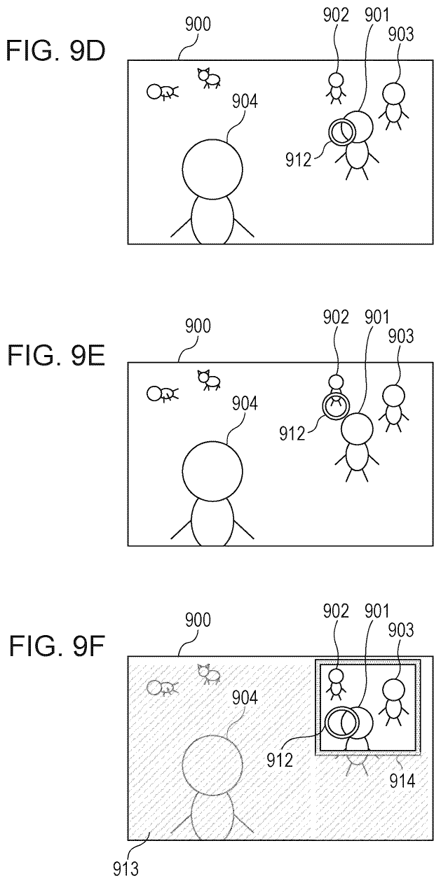

FIGS. 9A to 9F illustrate display examples of a game screen displayed on the HMD 810. Here, FIGS. 9A to 9C illustrate an example in which a mode for correction when the user has not selected the target of attack (aim assist mode) is invalid, and FIGS. 9D to 9F illustrates an example in which the mode is valid.

FIG. 9A illustrates a display example of a game screen in which a plurality of attack targets 901 to 904 is virtually approaching the user who wears the head set 800 and is playing an action game. The aim assist mode is invalid. At that time, a gaze magnification frame 910 is displayed at a position based on a user's gaze detected by the gaze detection unit (not shown) of the HMD 810. The gaze magnification frame 910 moves from the position shown in FIG. 9A to the position shown in FIG. 9B as the user's gaze moves. When a gaze confirmation operation (specifically, a depression of the multi-button 822 or a press of the set button 75) is performed by the user thereafter, the area within the range of the gaze magnification frame 910 is magnified as illustrated in FIG. 9C. This enables the user to accurately determine the attack target on the magnified display screen.

FIGS. 9D and 9E are screen examples of an action game when the aim assist mode is valid. Not the gaze magnification frame 910 but a gaze pointer 912 is displayed, with which the user can select an attack target. At that time, when a position slightly offset from the attack target is selected, as with the gaze pointer 912 in FIG. 9E, an attack target is determined based on the automatic selection condition that an attack target closest to the gaze pointer 912 is selected. As a result, if the attack target 901 meets the closest attack target, the position of the gaze pointer 912 is automatically corrected as illustrated in FIG. 9D. In this state, the user can give an attack instruction.

FIG. 9F is a display example of a screen in which an attack target can be selected more easily when the aim assist mode is valid. In this case, not the gaze magnification frame 910 but a selection frame 914 and the gaze pointer 912 are displayed. The gaze pointer 912 is displayed so as to follow the gaze. The area outside the selection frame 914 is displayed as a gray-out area 913, which indicates that the gaze pointer 912 cannot be moved out of the selection frame 914. Such display prevents the user from selecting the attack target 904 that the user does not want to attack, making it easier to select an attack target desired by the user.

In this manner, the system control unit of the HMD 810 controls the operation such that different operations are executed in response to the same gaze confirmation operation performed by the user: when the aim assist mode is invalid, a magnified display is provided at the gaze position; and when the aim assist mode is valid, a desired attack target is selected.

### Fourth Embodiment

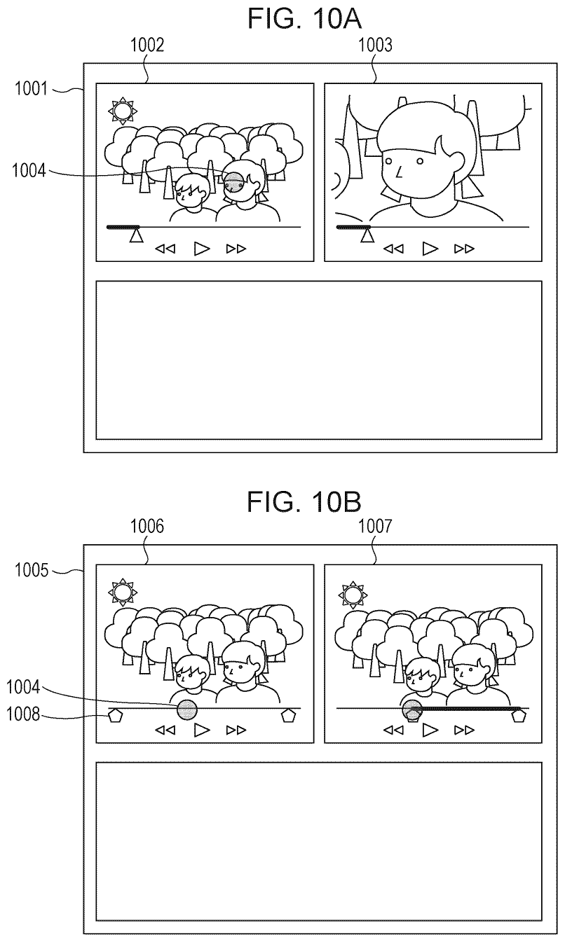

FIGS. 10A and 10B illustrate examples of a video editing screen of a personal computer (PC) according to a fourth embodiment. The PC includes a central processing unit (CPU), a random-access memory (RAM), a read-only memory (ROM), a storage, a network interface (I/F), a gaze detection unit, a display unit, and the like. FIG. 10A illustrates a screen for editing a video to display it in a magnified manner from a certain frame onward. FIG. 10B illustrates a screen for editing a video to trim it. Thus, modes for video editing include a magnification editing mode (FIG. 10A) and a trimming editing mode (FIG. 10B). Here, the frame refers to a single still image that constitutes a video. For example, a one-minute video is constituted by playing thirty still images (i.e., thirty frames) in sequence.

In the magnification editing mode of a PC, the CPU of the PC controls the display such that a magnification editing screen 1001 including a video 1002 before being magnified and a preview video 1003 after being magnified is displayed on the display unit. The user plays back the video 1002 before being magnified and determines a frame to be magnified. When a user's gaze is detected in the frame to be magnified, the CPU of the PC controls the display such that the video is magnified at a gaze position based on the user's gaze. At that time, the CPU of the PC controls the display such that the video is magnified at the gaze position in response to a user's gaze confirmation operation. One example of the gaze confirmation operation is a click of a mouse. In the preview video 1003, a magnified frame can be viewed. In FIG. 10A, the CPU of the PC controls the display such that a gaze pointer 1004 is displayed at a gaze position based on the user's gaze, allowing the user to confirm the position to be magnified.

In the trimming editing mode of the PC, the CPU of the PC controls the display such that a trimming editing screen 1005 including a video 1006 before trimming editing and a preview video 1007 after trimming editing is displayed on the display unit. The user plays back the video 1006 before trimming editing and determines the first frame and the last frame for constituting a desired video. FIG. 10B illustrates, in particular, an example in which the first frame is to be determined. The CPU of the PC controls the display so that a cursor 1008 is moved to a gaze position based on the user's gaze and displayed. This allows the first frame that constitutes a desired video to be determined. At that time, the CPU of the PC controls the display such that the cursor 1008 is moved to the gaze position in response to a user's gaze confirmation operation. One example of the gaze confirmation operation is a click of a mouse. In a preview video 1007 after trimming editing, the first frame that constitutes a desired video can be confirmed. In FIG. 10B, the CPU of the PC controls the display such that the gaze pointer 1004 is displayed at a gaze position based on the user's gaze, thereby enabling the user to confirm, on the screen, the position to which the user intends to move the cursor 1008.

In this manner, the CPU of the PC controls the operation such that different processes are executed in response to a gaze confirmation operation performed by the user: in the magnification editing mode, a magnified display is provided at the gaze position; and in the trimming editing mode, the first frame and the last frame that constitute a desired video are selected.

The display format of the gaze pointer described with reference to FIGS. 5A to 5L, FIGS. 9A to 9F, and FIGS. 10A and 10B are illustrative only. The display format may be not only a combination of an outer circle and an inner circle but also only an outer circle or only an inner circle. A means for toggling among such display formats may be provided. The layer order may be changed depending on the display format. For example, in the case of a gaze pointer display format in which only an outer circle is used, the other GUI components are not hidden by an inner circle, and therefore, for example, the gaze pointer 506 may be displayed on the upper layer.

The electronic device, the control method for the electronic device, and the program according to the present disclosure enables multiple processes related to gaze input to be executed in response to a specific operation performed by a user.

### Other Embodiments

The various control operations described above as being performed by the system control unit 50 of the image capturing apparatus 100 or the CPU of a PC may be executed by a single hardware component, or the control of the entire apparatus may be performed by a plurality of hardware components (for example, multiple processors or circuits) sharing the processing.

The present disclosure may also be implemented by executing the following processing. That is, software (program) for realizing the functions of the embodiments described above is supplied to a system or apparatus via a network or various storage media, and a computer (or CPU, MPU, or the like) of the system or apparatus reads and executes the program code. In such a case, the program and the storage medium storing the program constitute the present disclosure.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. An electronic device comprising:
a detection unit configured to detect a gaze position of a user who views a display unit configured to display a live-view image captured by image capturing unit;
an operation unit configured to receive an operation performed by the user;
a mode switching unit configured to switch between an AF mode and an MF mode; and
a control unit configured to execute, in response to a specific operation performed by the user on the operation unit, in the live-view image displayed on the display unit,
(1) in the AF mode, a first process of determining a position where AF is to be executed based on the gaze position on the live-view image detected by the detection unit, and
(2) in the MF mode, a second process for assisting manual focusing based on the gaze position on the live-view image detected by the detection unit,
wherein, in the second process, performing control such that the second process is completed in response to completion of the specific operation.

2. The electronic device according to claim 1, wherein the second process for assisting manual focusing is a process for displaying the live-view image in a magnified manner based on the gaze position.

3. The electronic device according to claim 1, wherein the second process for assisting manual focusing is a process for superimposing information on an in-focus state on the live-view image.

4. The electronic device according to claim 3, wherein the second process for assisting manual focusing is a peaking display process for highlighting a focused portion in the live-view image.

5. The electronic device according to claim 1, wherein, in the MF mode, when a guide for assisting manual focusing is displayed in the live-view image, the control unit performs control such that the second process is not executed even when the specific operation on the operation unit is performed by the user, and when a guide for assisting manual focusing is not displayed in the live-view image, the control unit performs control such that the second process is executed when the specific operation on the operation unit is performed by the user.

6. The electronic device according to claim 5, wherein, in the MF mode, in a case where the guide for assisting manual focusing is displayed in the live-view image, when the specific operation on the operation unit is performed by the user, a frame is displayed on a subject on which the guide is to be displayed, or the subject on which the guide is to be displayed is tracked based on the gaze position detected by the detection unit.

7. The electronic device according to claim 1, wherein the specific operation on the operation unit is an operation for determining a position where the first process and the second process are to be executed based on the gaze position.

8. The electronic device according to claim 1, wherein the specific operation on the operation unit is a depression of a button for providing an instruction to execute AF or a half-press of a button for providing an instruction to perform image capturing.

9. The electronic device according to claim 1,
wherein the control unit performs control such that the live-view image is displayed in a partially magnified manner in response to a depression of a zoom button different from the operation unit, and even after the depression of the zoom button is completed, the magnified display is maintained, and
wherein, in the second process executed in response to the specific operation on the operation unit, the control unit performs control such that the live-view image is temporarily displayed in a magnified manner based on the gaze position detected by the detection unit.

10. The electronic device according to claim 1,
wherein, in the live-view image, the control unit displays a gaze pointer so as to follow the gaze position detected by the detection unit, and
wherein, while the second process is executed by the control unit, the control unit does not display the gaze pointer is not displayed.

11. The electronic device according to claim 1, wherein the electronic device is an image capturing apparatus including the image capturing unit and a recording unit configured to record the live-view image captured by the image capturing unit into a recording medium.

12. A control method for an electronic device, the method comprising:
detecting a gaze position of a user who views a display unit configured to display a live-view image captured by image capturing unit;
receiving an operation performed by the user;
switching between an AF mode and an MF mode; and
executing, in response to a specific operation performed by the user on the operation unit, in the live-view image displayed on the display unit,
(1) in the AF mode, a first process of determining a position where AF is to be executed based on the gaze position on the live-view image detected by the detection unit,
(2) in the MF mode, a second process for assisting manual focusing based on the gaze position on the live-view image detected by the detection unit,
wherein, in the second process, performing control such that the second process is completed in response to completion of the specific operation.

13. A program for causing a computer to execute the control method for an electronic device according to claim 12.

14. A non-transitory storage medium storing a program for causing a computer to execute the control method for an electronic device according to claim 12.
